(19) United States
(12) Patent Application Publication
(10) Pub. No.: US 2005/0211688 A1
(43) Pub. Date: Sep. 29, 2005

(54) Method for hybrid multiple-thickness laser-arc welding with edge welding

(76) Inventors: Olivier Matile, Paris (FR); Philippe Lefebvre, Meulan (FR)

Correspondence Address: Air Liquide;Intellectual Property Department, 2700 Post Oak Blvd, Ste. 1800, Houston, TX, 77056, US

(21) Appl. No.: 10/513,762

(22) PCT Filed: Apr. 11, 2003
(86) PCT No.: PCT/FR03/01155

§ 371 Date: Nov. 5, 2004

(30) Foreign Application Priority Data
May 7, 2002 (FR) 02/05687

(51) Int. Cl. B23K 9/00

(52) U.S. Cl. 219/137 R

(57) ABSTRACT

A method for the hybrid laser-arc welding of several metal workpieces. The welding process uses at least one laser beam and at least one electric arc. The metal workpieces are stacked in a multiple-thickness configuration and the laser beam and the electric arc are used to weld the edges of the multiple-thickness configuration.

The present invention relates to the application of a hybrid welding method, combining a laser beam with an electric arc, to multi-thickness welding, that is to say to the joining together of several metal workpieces stacked on one another by welding, in which the melting takes place along edges, that is to say along the lateral edges of the workpieces to be welded.

It is known that multi-thickness welding, that is to say the welding of several metal workpieces superposed on one another, in general at least three workpieces superposed on one another, is not easy to achieve from the industrial standpoint.

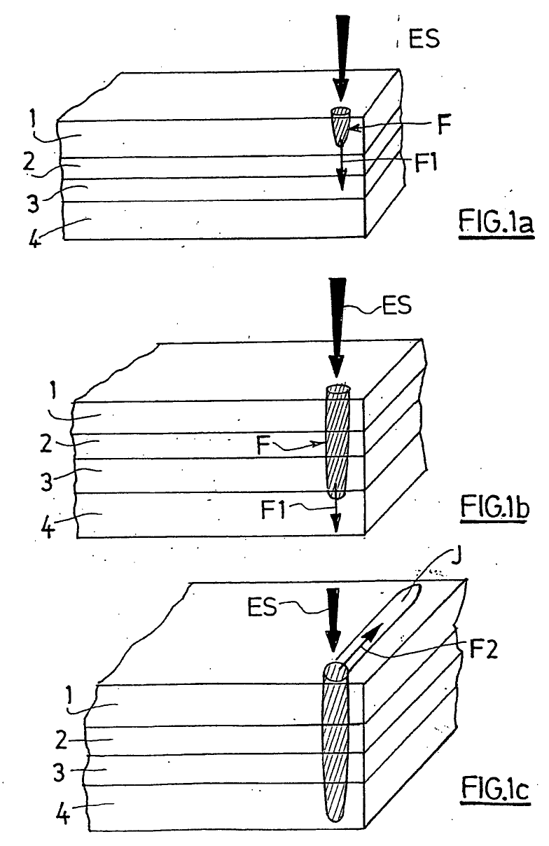

At the present time, as shown in FIGS. 1a to 1c, when several superposed workpieces 1 to 4 have to be joined together by welding along a weld joint J, for example by laser welding, arc welding or electron beam welding, it is conventional to melt the workpieces 1 to 4 by starting the melting F on the lateral surface of the first workpiece 1 that lies immediately opposite the welding torch delivering the welding energy ES (i.e. the electric arc, laser beam, electron beam, etc.), to continue this melting F through the entire thickness of this first workpiece 1 and then through the successive thicknesses of the workpieces 2 to 4 positioned beneath the first workpiece 1 (in the direction of the arrow F1) until complete melting along the thickness of the workpieces 1 to 3 and complete or partial melting of the last workpiece 4 located beneath the stack, that is to say the workpiece furthest away from the first workpiece 1, are obtained. Once this melting has been achieved, the welding torch and the workpieces 1 to 4 are moved relative to one another so as to continue this melting along the entire welding path (along the direction of the arrow F2) so as to form the desired weld joint J.

However, this method of welding several superposed workpieces raises several problems.

Firstly, it is known that having to achieve total penetration of almost all of the workpieces requires the application of greater welding energy the larger the number of workpieces to be joined together and above all the greater the total thickness to be melted.

Consequently, if the energy is insufficient the welding of the last workpiece, that is to say the one located beneath the stack, may be imperfect or deficient.

Moreover, when the workpieces to be welded are thin sheets, typically sheets with a thickness of 0.3 to 1.5 mm, it is often observed that the ends of these sheets are deformed, owing to the high energy applied during the welding, resulting in a raising of these edges or ends, which may pose subsequent corrosion problems and present hazards to users, because of the presence of sharp projecting edges.

Secondly, the clamping operation, that is to say the operation consisting in pressing the sheets of this type of assembly against one another and holding them in place, is not easy to carry out as there is often not enough space for positioning the assembling jaws on each side of the weld bead.

The object of the present invention is therefore to propose a welding method for solving the above problems and for obtaining effective and improved welding of several superposed metal workpieces, that is to say multi-thickness welding.

The solution of the invention is therefore a hybrid arc/laser welding method for several metal workpieces to be welded using at least one laser beam and at least one electric arc, characterized in that said metal workpieces are superposed in a multi-thickness configuration and in that said laser beam and said electric arc weld, along edges, said multi-thickness configuration.

Depending on the case, the method of the invention may comprise one or more of the following technical features:
the electric arc and the laser beam strike and weld the same zone located on the edges;
the electric arc and the laser beam strike at approximately mid-distance along the thickness (E) of the multi-thickness configuration;
the workpieces are metal plates or sheets;
the laser beam is generated by a laser oscillator of CO₂ or YAG type;
the multi-thickness configuration comprises from 2 to 100 workpieces, preferably from 3 to 10 workpieces;
the multi-thickness configuration has a total thickness (E) of between 0.5 and 20 mm, preferably from 1 to 10 mm;
the laser beam and the plasma arc are delivered, being combined together, via the same orifice of a welding nozzle;
during the welding, a gas containing argon or helium, or both these, is used;
the electric arc is generated by a consumable or nonconsumable electrode;
the workpieces to be welded are made of a material chosen from ferritic or austenitic, alloy or nonalloy steels, optionally coated with a zinc coating; and
the depth of penetration (D) of the edge weld is between 0.5 mm and 10 mm preferably between 0.5 to 1 mm.

### Illustrative Example

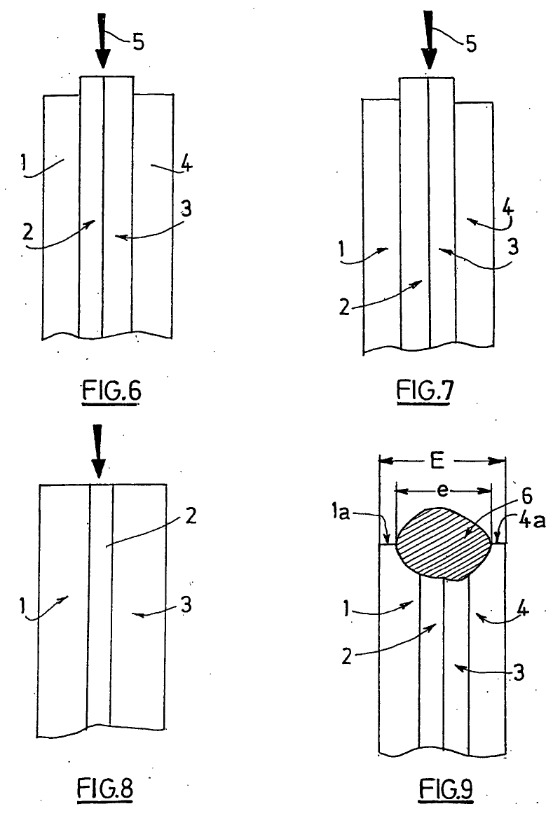

The hybrid arc/laser welding method for several super-posed workpieces in a multi-thickness configuration according to the invention is illustrated in FIGS. 2 to 10.

According to the invention, as shown in FIG. 2, the metal workpieces 1 to 4 to be joined together by welding, which in this case are four steel sheets or plates, are firstly superposed in the multi-thickness configuration in which they have to be welded.

More precisely, the workpieces 1 to 4 are positioned in such a way that their respective edges 1a to 4a are located facing the welding head by which the laser beam and the electric arc are delivered.

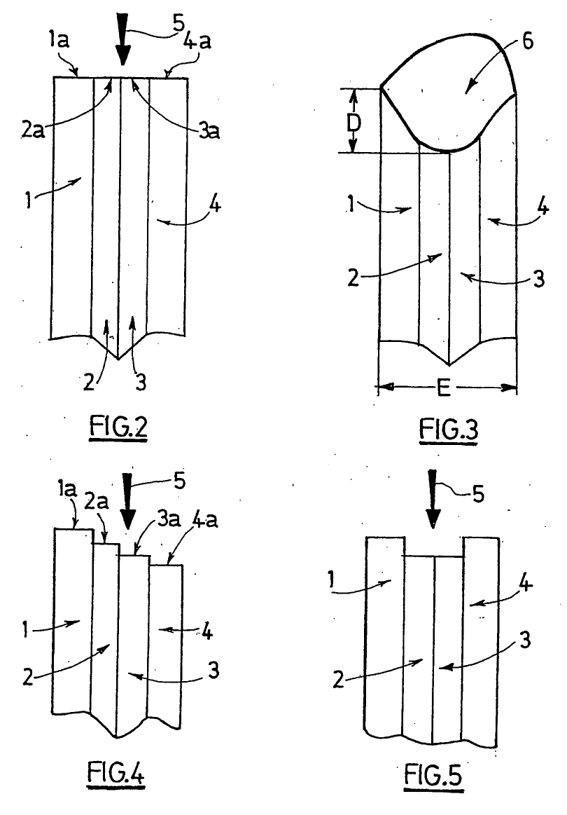

The laser beam and the electric arc (which are indicated schematically by the arrow 5) then strike the edges 1a to 4a of the workpieces 1 to 4 of the multi-thickness assembly or configuration so as to melt said edges 1a to 4a and subsequently form a weld joint 6 between said metal workpieces at said edges (1a to 4a) by solidification of the molten metal, as shown in FIGS. 3, 9 and 10.

In other words, the welding method of the invention relies on joining the workpieces together by the melting of the edges 1a to 4a, that is to say the edges located at the ends of the workpieces 1 to 4 to be joined, under the combined effect of the laser beam and the electric arc, and no longer by melting, by total penetration of the workpieces with welding starting on one of the lateral surfaces of the workpieces, as conventionally carried out in the prior art and illustrated in FIGS. 1a to 1c.

The weld joint 6 may be formed by total melting of the edge of each of the workpieces 1 to 4, that is to say along the entire thickness E, as illustrated in FIG. 3, or else by total melting of the workpieces 2, 3 located at the center of the assembly and only partial melting of the edges of the workpieces 1, 4 located on each side of the multi-thickness assembly, as illustrated in FIG. 9 which shows that, although part of the edges 1a and 4a of the workpieces 1 and 4 respectively has not been melted, effective welding 6 of the multi-thickness assembly is nevertheless obtained, but with a smaller thickness e (e<E).

Thanks to the method of the invention, since total melting of the entire thickness E of the multi-thickness assembly is unnecessary (see FIG. 9), it will be readily understood that the amount of energy to be applied is less than that conventionally applied in the prior art (FIG. 1a to 1c), which correspondingly minimizes the risk of deformation of the welded workpieces.

In addition, since the welding according to the invention is carried out along the edges, the ends of the workpieces 1 to 4 thus welded can no longer rise and constitute sharp projecting edges hazardous to users and conducive to subsequent corrosion.

Moreover, the hybrid method makes it possible to obtain both penetration and spreading of the bead needed for edge welding, as neither the laser alone nor the electric arc alone make it possible to achieve both the welding speed and the penetration and spreading compatible with good industrial productivity. As an example, for a 3 mm multi-thickness configuration in which four sheets of 1 and 0.5 mm thickness are welded along the edges with a 3 kW CO₂ laser power and a 130 A arc current, welding speeds of around 4 to 5 m/min are obtained.

The method of the invention may not only be used to weld workpieces whose edges 1a to 4a lie in one and the same plane, as shown in FIG. 2, but also to weld workpieces whose edges 1a to 4a lie in different planes, for example edges forming a staircase-like assembly (FIG. 4) or assemblies with several levels or stages (FIGS. 5 to 7).

Moreover, although the method has been exemplified within the context of welding a multi-thickness configuration from four plates, it proves to be equally applicable to configurations comprising only two or three workpieces, for example a configuration with three workpieces 1 to 3 as illustrated in FIG. 8 or, alternatively, configurations, comprising at least five workpieces. In all cases, it is essential for the laser beam and the arc to strike and melt the workpieces along the edges, that is to say in the direction of the arrow 5 in FIGS. 2 to 8.

The method of the invention makes it possible to weld multi-thickness assemblies whose total thickness is between 0.5 mm and 20 mm. The workpieces to be welded may each have the same thickness or different thicknesses.

The hybrid arc/laser welding method applicable to the present invention is quite conventional and is based on a combination of a laser beam and an electric arc that strike the same point or the same zone, so that the arc energy and the beam energy combine to obtain effective melting of the workpieces to be welded.

This technique is very well known to those skilled in the art and hybrid arc/laser welding methods have been described for example in the documents: EP-A-1 162 026; EP-A-1 160 047; EP-A-1 160 046; EP-A-1 160 048; WO-A-02/16071; EP-A-793 558; EP-A-782 489; EP-A-800 434; U.S. Pat. No. 5,006,688; U.S. Pat. No. 5,700,989; EP-A-844 042; Laser GTA Welding of aluminium alloy 5052, T. P. Diebold and C. E. Albright, 1984, p. 18-24; SU-A-1 815 085; U.S. Pat. No. 4,689,466; Plasma arc augmented laser welding, R. P. Walduck and J. Biffin, p. 172-176, 1994; or TIG or MIG arc augmented laser welding of thick mild steel plate, Joining and Materials.

The arc/laser method consists in generating an electric arc between a consumable or nonconsumable electrode and the workpiece or workpieces to be welded, and in focusing a high-power laser beam, especially a YAG-type or CO₂-type laser, in the arc zone, that is to say near or in the joint plane to be welded.

Application of a hybrid arc/laser welding method requires the use of a welding head for combining the laser beam, its focusing device and a suitable, consumable or nonconsumable, welding electrode. The laser beam is emitted simultaneously with or subsequently to the formation of the arc so that said beam combines with the arc.

Several head configurations are described in the abovementioned documents and it may be pointed out, in summary, that the laser beam and the electric arc may be delivered by one and the same welding head, that is to say they emerge via the same orifice, or else by two separate welding heads, one delivering the laser beam and the other the electric arc or plasma jet, both these combining in the welding zone, as taught for example by documents WO-A-01/05550 or EP-A-1 084 789.

To produce the weld joint, it is essential to use an assistance gas, for assisting the laser beam and shielding the welding zone from external attack, and a gas for the electric arc, in particular a plasma gas used to create the plasma arc jet in the case of a plasma arc method.

The electric arc may be a plasma arc jet, an TIG arc, generated by a nonconsumable tungsten electrode, or an MIG arc, generated at the end of a consumable electrode, making it possible, as it progressively melts, to supply the metal weld pool with additional filler metal. In all cases, the laser beam and the arc combine so as to achieve a local concentration of power density (welding energy) sufficient to melt the edges 1a to 4a of the workpieces 1 to 4 to be welded.

The invention may be used to join together metal workpieces having the same or different thicknesses and/or metallurgical compositions or metallurgical grades that are the same or different.

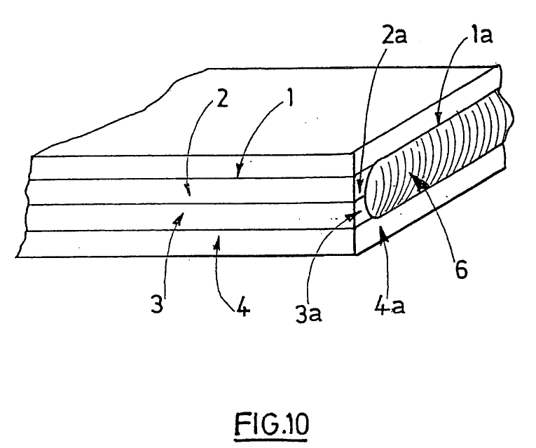

It goes without saying that, to obtain a complete weld joint 6 as shown in FIG. 10, the workpieces to be welded and the welding head undergo a relative displacement movement one with respect to the other, that is to say either the workpieces are fixed and the welding head moves, or vice versa.

Moreover, it should be emphasized that the welding phase can take place in one or more passes.

The method of the invention is applicable to the welding of any structure formed from several metal thicknesses that can be edge-welded and be used, for example, to weld parts of heat exchangers.

The method of the invention is also applicable to the edge welding of raised edges of tubes or of sections, that is to say workpieces with the same thickness or different thicknesses, the edges of which project to the outside, being edge-welded according to the method of the invention.

1-12. (canceled)

13. A method which may be used for hybrid arc/laser welding several metal workpieces, said method comprising:
a) positioning said workpieces in a multi-thickness configuration; and
b) welding along the edges of said multi-thickness configuration with at least one laser beam and at least one electric arc.

14. The method of claim 13, wherein said arc and said laser strike and weld substantially the same place on said edges.

15. The method of claim 14, wherein said laser and said arc strike said configuration at approximately midway through its total thickness.

16. The method of claim 13, wherein said workpieces comprise at least one member selected from the group consisting of:
a) metal plates; and
b) metal sheets.

17. The method of claim 13, further comprising generating said laser with a laser oscillator, wherein said oscillator comprises at least one member selected from the group consisting of:
a) a CO₂ type laser oscillator; and
b) a YAG type laser oscillator.

18. The method of claim 13, wherein said configuration comprises between about 2 to about 100 workpieces.

19. The method of claim 18, wherein said configuration comprises between about 3 to about 10 workpieces.

20. The method of claim 13, wherein said configuration has a total thickness of between about 0.5 mm and about 20 mm.

21. The method of claim 13, further comprising delivering said laser and said arc, combined together, through the same orifice of a welding nozzle.

22. The method of claim 13, further comprising the addition of a welding gas, wherein said gas comprises at least one member selected from the group consisting of:
a) a welding gas containing argon;
b) a welding gas containing helium; and
c) a welding gas containing argon and helium.

23. The method of claim 13, wherein the depth of penetration of said edge weld is between about 0.5 mm and about 10 mm.

24. The method of claim 13, further comprising generating said arc with an electrode, wherein said electrode comprises at least one member selected from the group consisting of:
a) a consumable electrode; and
b) a nonconsumable electrode.

25. The method of claim 13, wherein said workpieces are made of a material, wherein said material comprises at least one member selected from the group consisting of:
a) a ferritic steel;
b) an austenitic steel;
c) an alloy steel; and
d) a nonalloy steel.

26. The method of claim 25, wherein said workpieces are coated with a zinc coating.
